(19) United States
(12) Patent Application Publication
(10) Pub. No.: US 2013/0229643 A1
(43) Pub. Date: Sep. 5, 2013

(54) ROTATING LASER

(71) Applicant: Bernd Moeller, Luechingen (CH)

(72) Inventor: Bernd Moeller, Luechingen (CH)

(73) Assignee: LEICA GEOSYSTEMS AG, Heerbrugg (CH)

(21) Appl. No.: 13/884,587

(22) PCT Filed: Nov. 24, 2011
(86) PCT No.: PCT/EP2011/070927

§ 371 Date: May 9, 2013

(30) Foreign Application Priority Data
Nov. 25, 2010 (EP) 10192628.5

(51) Int. Cl. G01C 3/08

(52) U.S. Cl. CPC G01C 3/08
USPC 356/4.01

(57) ABSTRACT

A rotating laser has a source of electromagnetic radiation for production of a reference beam, and deflection means, which can rotate about a rotation axis, by which means a laser area is defined when rotated, and with the reference beam passing over a reference path. The rotating laser has a functionality for perpendicular alignment of the laser area relative to the surface, with the control means being designed such that the laser area is automatically variably inclined relative to the surface by swiveling means swiveling the rotation axis, with a reference line range from the reference line to the rotating laser being determined for each of the respective inclination angles, and with that inclination angle of the laser area being determined as the perpendicular inclination angle at which the laser area includes the reference line with the respective shortest determined reference line range, and therefore being perpendicular to the surface.

The invention relates to a rotating laser for generating a reference beam according to the precharacterizing clause of claim 1, and to a method for the orientation of a laser area according to the precharacterizing clause of claim 10.

Rotating lasers, which are used in order to mark points or objects or to establish paths or reference lines, have been used for many years in the industrial field or in the construction industry. Using them, it is possible to project horizontal, vertical or diagonal planes, which offer a marker for orienting or positioning objects.

A rotating laser is usually constructed from rotating optics, which are part of a laser unit and by means of which a reference laser beam can be emitted while being moved in such a way that a path or a line which is perceptible, or detectable by detectors, is generated on a surface. So that the path can be orientated in accordance with defined specifications, the laser unit is swivelable in two mutually perpendicular directions relative to a housing enclosing the laser unit. For emission of the laser from the housing, the housing additionally comprises optically transparent windows or openings.

U.S. Pat. No. 5,852,493 discloses a self-orienting rotating laser having a double inclination mechanism. The laser comprises a light source connected to a frame, the frame being universally suspended and the frame and suspension being combined with a rotatable base. Furthermore, control mechanisms orientated in two directions are arranged on the suspension in order to orientate the light source. Two position sensors are arranged on the frame at an angle of 90° to one another, these being mounted rotatably. By displacement of the sensors from a reference position, the control mechanisms can displace the light source into a position so that the change in the inclination of the sensors resulting therefrom corresponds again to their reference, and the light source then has a defined inclination. In one embodiment, two sensors are used, both of which are arranged on a common mount and can thereby be influenced simultaneously.

EP 2 144 037 discloses a rotating laser, in particular a self-compensating rotating laser, i.e. one which horizontalizes itself, and a method for measuring the inclination of its rotation axis. This rotating laser comprises a base and a laser unit for emission of a laser beam and rotation thereof about a rotation axis, so that the rotating laser beam defines a laser plane. The laser unit is configured to be swivelable relative to the base, and the rotation axis can thereby be inclined in at least one direction. Furthermore, an inclination sensor is arranged on the device in order to measure the inclination of the axis, this sensor changing its position together with the laser unit and being mounted rotatably about the rotation axis of the laser unit. It is thus possible to measure the inclination of the rotation axis in at least two different positions, and an absolute inclination can be derived therefrom.

Rotating lasers were not originally intended for measuring distances to points on the surfaces onto which the laser beam is projected. Now, however, embodiments are already known from the prior art which combine a rotating laser and a distance measurement functionality, for example in order to obtain range information together with the projection of a plane and thereby generate a plan of a space.

WO 2009/053085 describes a distance-measuring method, and a reference line-projecting and distance-measuring device, for example a rotating laser, in which the emission used for the projection, or at least the beam path thereof, is likewise used for a range measurement. Here, with the aid of an optical measurement beam, a defined measurement path is travelled, or executed, that is to say the measurement beam is guided in such a way that the trajectory of its projection also corresponds to the reference line to be projected. In this case, a distance to at least one point of the measurement path is determined, the measurement path being executed, or travelled, at least once repeatedly for the determination of the distance. The distance determination is carried out using a distance meter which is integrated into the device, an emitted measurement beam preferably being coupled coaxially with the reference beam. This embodiment furthermore comprises two inclination sensors, by which a defined inclination angle of the laser plane can be determined. These sensors, provided for determination or adjustment of the position of the plane, at the same time represent a disadvantage of this embodiment since the accuracy achievable with the sensors is not sufficiently high for every application, and the sensors furthermore have only a limited measurement range, which permits use of the device primarily in an upright position, but not tilted in a lay-down position.

In the case of the previously known rotating lasers, accurate orientation of the laser plane or of a laser area relative to a surface, in particular perpendicularly to a surface, can only be carried out by a position change of the laser itself, or for instance by manually controlled swiveling of the emitted laser area. Exact orientation can therefore only be achieved with great time expenditure and furthermore can only be carried out limitedly accurately, in the scope of the accuracy of the user's eye for distances. The possibility of being able to carry out this orientation simply and rapidly furthermore exists only for well-trained, experienced and highly qualified users, as many details need to be taken into account. User-friendliness in the orientation of the laser area is therefore not provided. Under these circumstances, the orientation can become an elaborate and complicated process for the average user of a rotating laser. Furthermore, an adjusted orientation of the laser area cannot reliably be maintained accurately owing to disturbances in the position of the rotating laser, for example due to inadvertent impact on the laser.

It is consequently an object of the invention to provide an improved rotating laser for accurate and reliable perpendicular orientation of a laser area relative to a surface, this orientation being made possible rapidly, simply and in a user-friendly way.

It is another particular object of the invention to generate a perpendicular projection of a laser area relative to a surface in a vertical or horizontal direction.

These objects are achieved by implementing the characterizing features of the independent claims. Features which refine the invention in an alternative or advantageous way may be found in the dependent patent claims.

According to the invention, a rotating laser comprises a laser beam source, from which a laser beam which is visible or detectable by means of a detector is emitted. This laser beam is deflected by using motorized deflection means, for example deflecting mirrors, and used as a reference beam, by the movement of which—caused by that of the deflecting mirrors—a reference path is generated on a surface. In addition, means are provided for distance or range measurement to points on the surface by using the reference beam.

With this arrangement, the reference path is projected onto a surface, a laser area being defined by the reference path and, in particular, a line being generated on the surface. In order to implement a function according to the invention for orientation of the laser area, the rotating laser may in this case particularly be in a lay-down position, so that the projection extends for example over the bottom, wall or top in a space, in particular with the rotating laser being positioned to this end in such a way that the laser area is already roughly orientated perpendicularly relative to the wall before implementing the function. With the start of the function, the laser area is now moved over the wall within an angular range and the inclination of the laser area relative to the surface of the wall is thereby varied. During this, a distance from the rotating laser to the respective reference line on the surface is measured continuously. The inclination of the laser area may be carried out by swiveling a part of the rotating laser that comprises the deflection means, or by a swiveling movement of the deviating mirrors themselves. In addition, the respective position data and the values for the angular setting of the deflection means may be stored for each measurement and assigned to one another. After the angular range has been run through, the stored distances to the reference line are compared with one another and the shortest distance value is defined. Subsequently, by using the stored angle values, the laser plane or a laser area is projected in such a way that it extends through that reference line for which the shortest distance has been determined. In this case, it may be additionally taken into account that the projection does not extend at the edge of the previously defined angular range but lies within the limits of the angular range. When this condition is satisfied, a projection of a laser line or laser area onto a wall is obtained which is perpendicular relative to this wall and therefore has the shortest distance from the radiation source to the wall.

In contrast to other known rotating lasers and projection methods thereof, the present embodiment provides a system with which not only can a vertical or horizontal laser line be projected onto a surface, but the projection of a laser area can be orientated automatically in such a way that—as described—it is perpendicular relative to the surface.

With the present invention, the orientation can furthermore be carried out reliably and in an automated fashion, the resulting perpendicular positioning of the laser area relative to the surface furthermore having a high accuracy. It is advantageous in addition that the orientation is carried out simply and a high user-friendliness can be achieved, for example by carrying out the orientation by pressing a button and furthermore scarcely any further prior knowledge being necessary. High robustness in relation to external influences is furthermore provided in that the orientation function can be implemented continuously and therefore, for example, vibrations of the rotating laser or impacts, which may lead to changes in the orientation of the laser with respect to the surface, can be compensated for automatically. The simple and rapid repeatability of the automated orientation is a further advantage of the invention.

In order to determine the reference line with the shortest distance to the rotating laser, a complete run through the angular range and comparison of the distances measured in this case may, as an alternative, be partially obviated, and instead a continuous comparison of the distances may be carried out, the process being stopped as soon as a distance minimum is crossed, i.e. as soon as the previously decreasing distance values increase again, and the minimum thereby established represents the position of the reference line with the shortest distance to the rotating laser.

The swiveling of the laser area may be carried out by a laser core module which comprises a laser beam source and rotatable deflection means for guiding the laser beam, the laser beam being directed parallel to a rotation axis of the deflection means and being deflected when it strikes the deflection means. The complete module is additionally swivelable about at least one axis relative to the housing of the rotating laser, and therefore allows orientation of the emitted laser beam. The housing of the rotating laser remains in its original position during a swiveling movement of the module.

In the case of positioning of the rotating laser such that the shortest distances for points at the limit of the angular range are determined when running through the swivel range or angular range, the rotating laser may also carry out an additionally required coarse adjustment by moving the laser core module, so that the region scanned on the wall is changed and, after the adjustment, it is possible to cover a region on the wall which has the reference line with the respective shortest distance. Positioning of the rotating laser relative to the wall, which is necessary for this, may furthermore—or alternatively—also be carried out manually.

Furthermore, the distance determination of the reference line may be carried out in various ways. On the one hand, a relative distance of the individual reference lines with respect to one another may be determined by determining, for each line, the distance to a point on the line, the position of the point on the line being predetermined by an emission angle, remaining constant for all measurements, of the laser beam with respect to the rotation axis of the rotating laser, and swiveling of a laser area being carried out in a perpendicular direction relative thereto. Distance values are obtained in this way, which can be compared with one another and with which a distance minimum can be determined, so that perpendicular orientation of the laser area relative to the surface can be carried out. The distances determined in this way do not, however, correspond to the absolute distances, i.e. the angle-dependently shortest distances, on the reference lines to the rotating laser. In order to determine these absolute distances, the distances to at least two points on the reference line may initially be measured with a fixed swivel angle, and the profile of the reference line may be derived from the associated emission angles and the measured distance values. Swiveling of the laser area in the direction perpendicular thereto is not necessary in this case. The determination of the absolute distance may then be derived mathematically from this profile, by calculating a straight line which is perpendicular to the reference line and extends through the rotating laser, and determining the length from the laser to the intersection of the straight line with the surface. As an alternative to this, a larger number of distances to points on the reference line may be measured with a predetermined resolution, in turn respectively for a common fixed swivel angle. By comparison of these distances, a minimal distance value can in turn be determined, which corresponds to an absolute distance to the reference line. With a high resolution of measurement points, direct determination of the point with the shortest distance can be carried out, although if a coarse resolution of the measurement points is provided, then the minimum distance may be determined by a calculation, for example by means of fitting or regression, of a function representing the distances and emission angles may be determined by determining a minimum of this function.

In order to improve the accuracy during the orientation of the laser area, the values of the distance measurements and an emission angle, belonging thereto, of the laser area with respect to the rotating laser may be linked with one another, accumulated and average values may be derived therefrom so that the positions of the point with the shortest distance to the wall, or to the surface, can be determined more accurately.

In a particular embodiment, an inclination sensor may be provided on the rotating laser so that the reference line is guided parallel to the gravitational field of the Earth and can be moved in this orientation within the defined angular range. Under this condition, the distance to a fixed point on the reference path is now again measured and stored and, after the determination of this point with the shortest distance, a reference line or laser area parallel to the gravitational field is projected through this point, which in turn lies within the limits of the angular range, is therefore projected perpendicularly relative to the wall and represents the shortest distance from the radiation source to the wall. In this way, a laser area is generated which is not only perpendicular relative to the surface but also extends vertically.

In particular, a laser plane may also be orientated relative to two surfaces simultaneously. To this end, for example, two opposite walls may be selected, onto which the plane is projected and on which the distance to a reference line, which is respectively defined by the laser plane, is respectively determined. If these walls extend mutually parallel, then the laser planes may be orientated in such a way that, on each wall, the reference line with the shortest distance to the rotating laser lies in the plane and the latter is therefore perpendicular relative to both walls. If the profile of the two walls differs from a parallel orientation, however, then for each wall it is in turn possible to determine the reference lines which have the shortest range to the rotating laser, and record corresponding inclination angles. Subsequently, the laser plane may be orientated in such a way that the inclination angle of the plane corresponds to a central inclination angle between the angles determined for the two walls. In this way, the projection of a laser plane is obtained, which represents a type of common compensation plane for the two walls while having a determined angle not equal to 90° relative to the walls.

Furthermore, the positions of the points or the profile of the reference path may be converted into an external coordinate system, with the angular setting of the deflection means, or deflecting mirrors, the inclination of the laser plane and of the rotating laser and the distance to a point, or to all points, on a reference path being taken into account.

For illustration, embodiments of the rotating laser according to the invention and of the method for the orientation of a laser area will be described below alternatively in other words.

A rotating laser according to the invention comprises a source of electromagnetic radiation, in particular a laser beam source, for generating a reference beam, and deflection means, which can be rotated about a rotation axis, for rotating emission of the reference beam, so that a laser area is defined, the reference beam travelling along a reference path and at least a part of the reference path being perceptible as a reference line visually and/or by means of a detector on a surface. Furthermore, swiveling means are provided for swiveling the rotation axis about at least one axis, in particular about two axes, and a range measurement unit is provided for measuring ranges to points on the reference path. In addition, the rotating laser comprises control means for controlling the swiveling means and for comparing ranges.

According to the invention, the rotating laser has a functionality for perpendicular orientation of the laser area relative to the surface, the control means being formed in such a way that a varying inclination of the laser area relative to the surface is carried out automatically by swiveling the rotation axis. Determination of a reference line range from the reference line to the rotating laser respectively being carried out for the respective inclination angles, and determination furthermore being carried out of that inclination angle of the laser area as a perpendicular inclination angle, for which the laser area contains the reference line with the respectively shortest determined reference line range and is therefore perpendicular relative to the surface.

In particular, in the scope of the functionality, the inclination angle of the laser area may be adjusted to the perpendicular inclination angle.

In particular, in the scope of a refinement of the functionality, orientation of a laser area relative to a first and a second surface, lying opposite the first, may be carried out as follows. With the varying inclination of the laser area, reference line ranges to reference lines lying on the first and second surface are determined, for the first and second surface the determination of two inclination angles of the laser area is carried out as a first and second perpendicular inclination angle, for which the laser area respectively contains a first and second reference line with a respective first and second shortest determined reference line range, and is therefore perpendicular relative to the first and/or second surface, and adjustment of the inclination angle of the laser area is carried out to a central, in particular arithmetically averaged, inclination angle between the first and second perpendicular inclination angles.

In particular, the inclination angles and the reference line ranges respectively determined therefor may furthermore be linked together to form value pairs and stored in a database, particularly in a table. Furthermore, a range measurement in the scope of the invention may be carried out at least with parts of the reference beam reflected at the surface.

The rotating laser may furthermore comprise means for determining an emission angle of the reference beam with the aid of a setting of the guide means. In addition, measurement values for ranges to points at defined emission angles may be accumulated and an average value for measured ranges may be determined. In this way, an increase in the accuracy can be achieved when determining the ranges to points, and therefore also orientation of the laser plane can be carried out more exactly.

According to the invention, the determination of the reference line range to the rotating laser may be carried out with the aid of a range measurement to a point on the reference line. A position of the point on the reference line may to this end be defined by a predetermined emission angle of the reference beam, and the predetermined emission angle being maintained during swiveling of the laser area in a direction perpendicular to the laser area, the range to the point being taken into account as the reference line range to the rotating laser.

As an alternative, the determination of the range of the reference line to the rotating laser may be carried out by measurement of ranges and determination of emission angles to at least two points on the reference line. In addition, a profile of the reference line is in this case derived from the ranges and the emission angles, and the shortest path from the rotating laser to the reference line is calculated mathematically, this being taken into account as the reference line range to the rotating laser.

In particular, the determination of the range of the reference line to the rotating laser may also be carried out by measurement of ranges and determination of emission angles to a multiplicity of points on the reference line with a predetermined resolution, in particular with a resolution of 5-50 points per 10° of angle variation of the deflection means. In this case, a minimum range may be determined by a comparison of ranges to the points, in particular with a minimum range being determined by a calculation of a minimum of a function representing the ranges and emission angles, this being taken into account as the reference line range to the rotating laser.

Furthermore, the varying inclination of the laser area for the determination of the shortest reference line range to the rotating laser may be carried out until a minimum is established in a profile of a measurement curve recorded in this case.

The rotating laser may furthermore comprise a laser core module having a laser beam source and having the deflection means, which can be rotated about the rotation axis and which are provided as a guide means for a laser beam, the laser beam being emitted parallel to the rotation axis and the laser core module being swivelable about at least one axis, in particular about two axes. With this embodiment, coarse orientation of the rotating laser before implementing the functionality is not necessary, but may be carried out by the mobile module.

In addition, the orientation of the rotating laser relative to the gravitational field may be recorded with an inclination meter, and the laser area may be orientated parallel to the gravitational field. These two steps may be carried out before implementing the functionality, and cause vertical orientation of the laser area and finally perpendicular orientation relative to the surface.

With respect to the orientation of the rotation axis, or of the laser area, according to the invention the rotation axis or the laser plane can therefore be automatically orientated horizontally or vertically by means of the swiveling means, in particular with the horizontal or vertical orientation of the rotation axis being carried out as a function of a measurement value of an inclination sensor.

As regards the range measurement with the rotating laser according to the invention, according to the invention the range measurement unit may comprise an emission unit and a reception unit, and be formed in such a way that emission and reception of a measurement beam for the range measurement take place respectively in a parallel direction, in particular coaxially, in particular with the range measurement being able to be carried out by means of waveform digitization (WFD; as described in relation to FIG. 9).

In addition to a laser beam source emitting a reference beam, a second beam source likewise for generating laser radiation may be provided, which is suitable for being detected by a receiver, in particular after reflection from a surface, and therefore makes it possible to carry out the determination of a range in the radiation source to the surface precisely. The two beams may furthermore be guided together, offset mutually parallel or coaxially, in order to be able to carry out a range measurement respectively at the point which is defined by the reference beam.

Another aspect of the invention relates to a projection of reference lines onto a surface, the reference lines being projectable so that a first distance respectively between two neighboring lines is of equal size as, or identical to, a second distance of two other neighboring lines. Furthermore, the distance between the reference lines may be adjusted precisely by means of a defined variation of the inclination angle for the rotation axis or the laser area, so that parallel-offset lines are generated. Such a projection is based on a perpendicular orientation, according to the invention, of the laser area with respect to the surface and the measurements carried out in this case, or the measurement values determined (angles and ranges) on the surface. From the link, which can be generated in this context, of range measurement values and respective inclination angles the projection can be carried out at a defined position and with determined distances of the lines on the surface. According to the invention, at least a first and a second projection inclination angle can therefore be adjusted as an inclination angle for inclination of the laser area, in such a way that there is a defined distance between the reference lines generated on the surface with the at least two projection inclination angles, in particular with a multiplicity of projection inclination angles being adjustable and the distances between two respectively neighboring reference lines thereby generated on the surface being identical, or of equal size.

A method according to the invention for the perpendicular orientation of a laser area defined by emission, rotating about a rotation axis, of a reference beam, relative to a surface, the reference beam travelling along a reference path and at least a part being perceptible as a reference line visually and/or by means of a detector on the surface, comprises varying inclination of the laser area relative to the surface with determination of a reference line range from the reference line to the rotating laser respectively being carried out for the respective inclination angles, and determination of that inclination angle of the laser area as a perpendicular inclination angle, for which the laser area contains the reference line with the respectively shortest determined reference line range and is therefore perpendicular relative to the surface.

In the method according to the invention, in particular, adjustment of the inclination angle of the laser area to the perpendicular inclination angle is carried out.

Furthermore, in the scope of a refinement, according to the invention, of the method, orientation of a laser area relative to a first and a second surface, lying opposite the first, may be carried out. To this end, with the varying inclination of the laser area, reference line ranges to reference lines lying on the first and second surface are determined. Furthermore, for the first and second surface, the determination of two inclination angles of the laser area is carried out as a first and second perpendicular inclination angle, for which the laser area respectively contains a first and second reference line with a respective first and second shortest determined reference line range, and is therefore perpendicular relative to the first and/or second surface (32), and adjustment of the inclination angle of the laser area to a central, in particular arithmetically averaged, inclination angle between the first and second perpendicular inclination angles.

In addition, before the perpendicular orientation of the laser area, the laser area may be orientated roughly perpendicularly to the surface, and orientation of the laser area may furthermore be carried out parallel or perpendicular to the gravitational field, in particular horizontally or vertically. In this way, on the one hand, orientation, in particular to be carried out manually, of the laser area in the course of the measurement can be avoided, and on the other hand a vertical and a perpendicular projection relative to the surface of the laser area can be carried out by the parallel orientation.

Furthermore, an absolute position of at least one point, in particular of a plurality of points, on the reference path may be determined in relation to an external coordinate system, an emission angle being recorded according to a setting of a rotation axis provided for guiding the reference beam, and the range to this point being measured. In addition thereto, with the coordinates of the point on the reference path being determined in relation to the external coordinate system.

As regards the aspect of the determination of the reference line range, in the scope of the method according to the invention, the determination of a reference line range may be carried out by means of emission and reception of a measurement beam, the emission and reception taking place in parallel directions, in particular coaxially, in particular with the reference line range being determined by means of waveform digitization (WFD).

According to another aspect of the invention, in the scope of the method, at least a first and a second projection inclination angle may be adjusted as an inclination angle for the laser area, in such a way that there is a defined distance between the (in particular parallel) reference lines generated on the surface with the at least two projection inclination angles, in particular with a multiplicity of projection inclination angles being adjustable and the distances between two respectively neighboring reference lines thereby generated on the surface being identical, or of equal size.

In particular, a computer program product which is stored on a machine-readable medium, or a computer data signal embodied by an electromagnetic wave, having program code for carrying out the method for the perpendicular orientation of a laser area, defined by guiding a reference beam along a reference path, relative to a surface, in particular when the program is run in an electronic data processing unit of a rotating laser.

The method according to the invention and the rotating laser according to the invention are described in more detail below, purely by way of example, with the aid of specific embodiments schematically represented in the drawings, with further advantages of the invention being discussed. In detail,

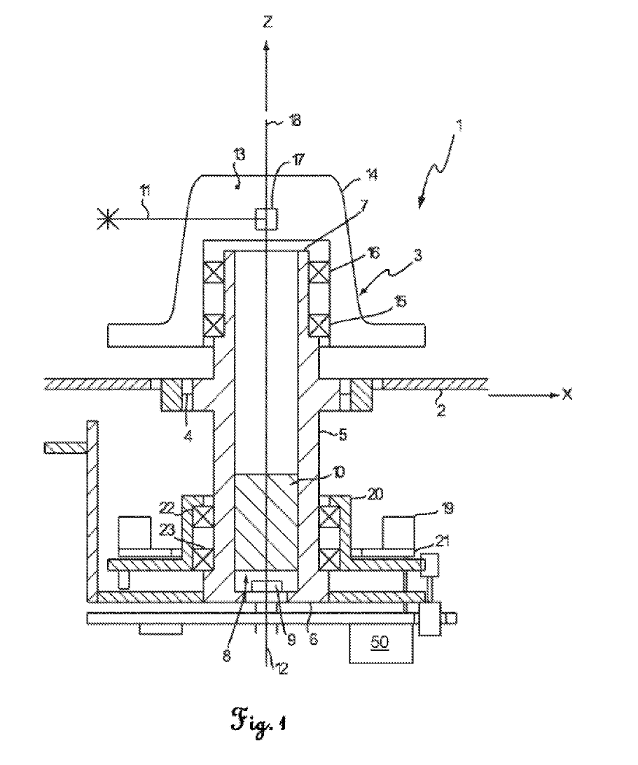

FIG. 1 shows an embodiment of a rotating laser according to the invention,

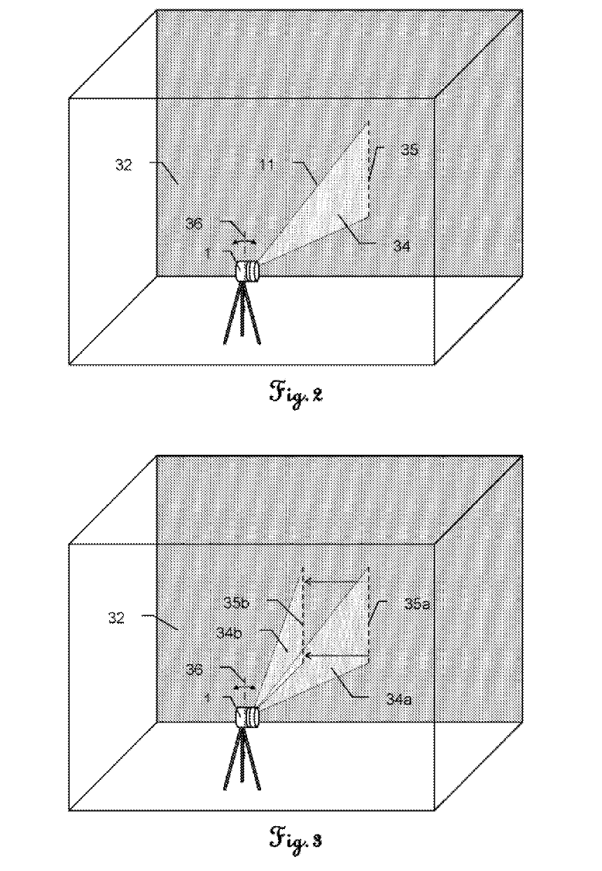

FIG. 2 shows a rotating laser according to the invention with projection of a laser area onto a surface,

FIG. 3 shows a rotating laser corresponding to the invention with laser projection, the projection being orientated perpendicularly relative to the surface,

FIG. 4 shows another embodiment of a rotating laser according to the invention with the orientation of a laser beam with respect to the surface,

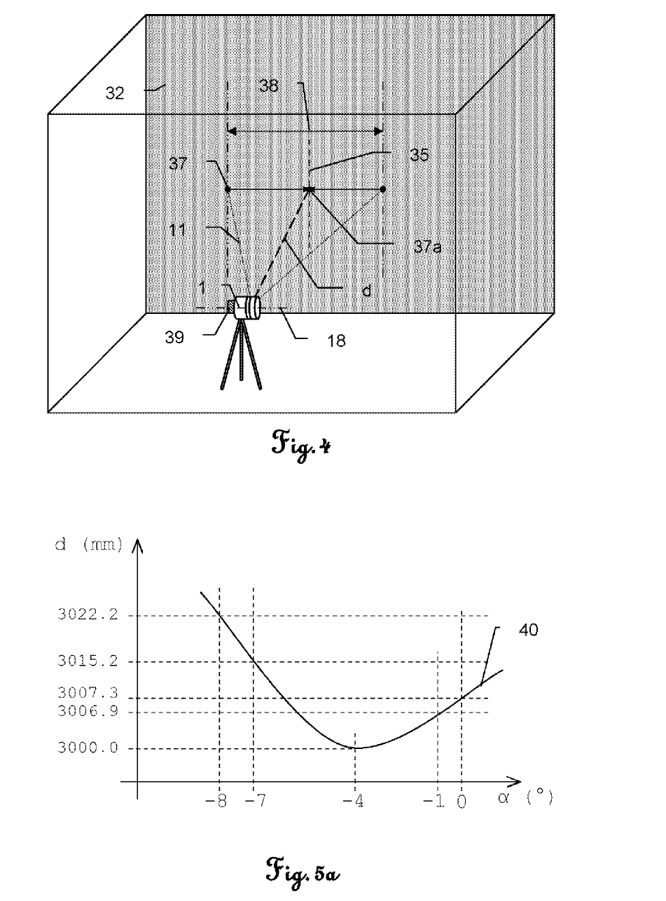

FIGS. 5a-b show measurement values, recorded for the orientation according to the invention of a laser area for ranges and angles in a graphical and tabular representation,

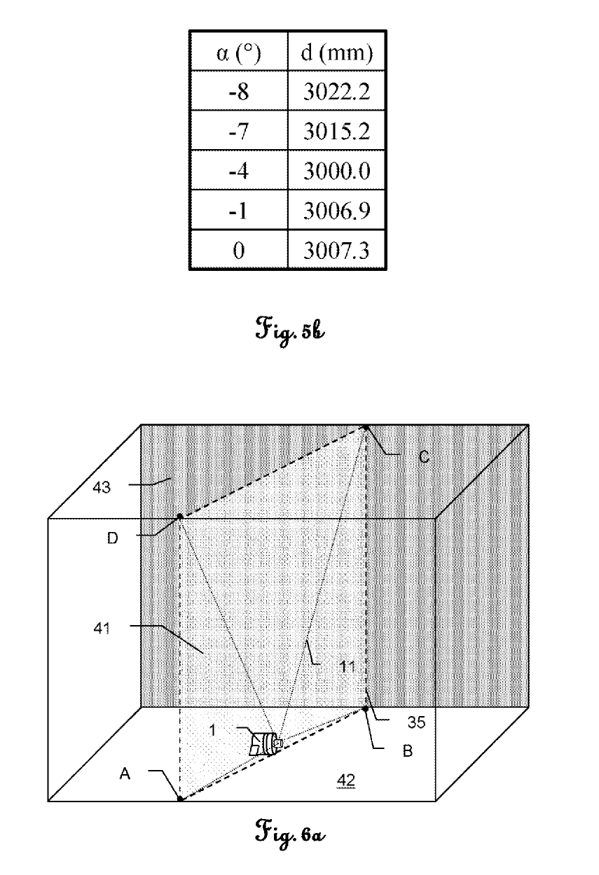

FIGS. 6a-b show a rotating laser according to the invention, projecting a laser plane, and a graphical representation of measurement values along a reference line,

FIG. 7 shows a rotating laser according to the invention, projecting a laser plane, the laser plane being orientated perpendicularly relative to the surface, and

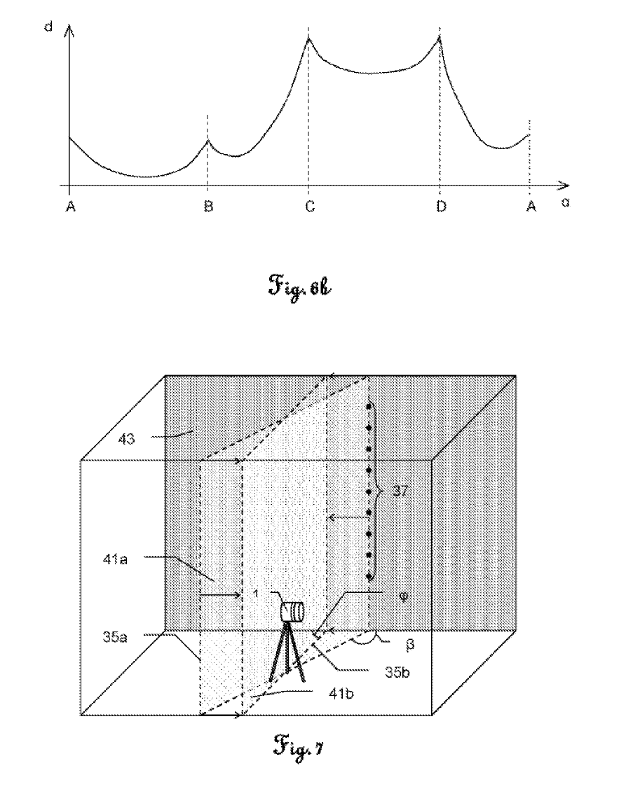

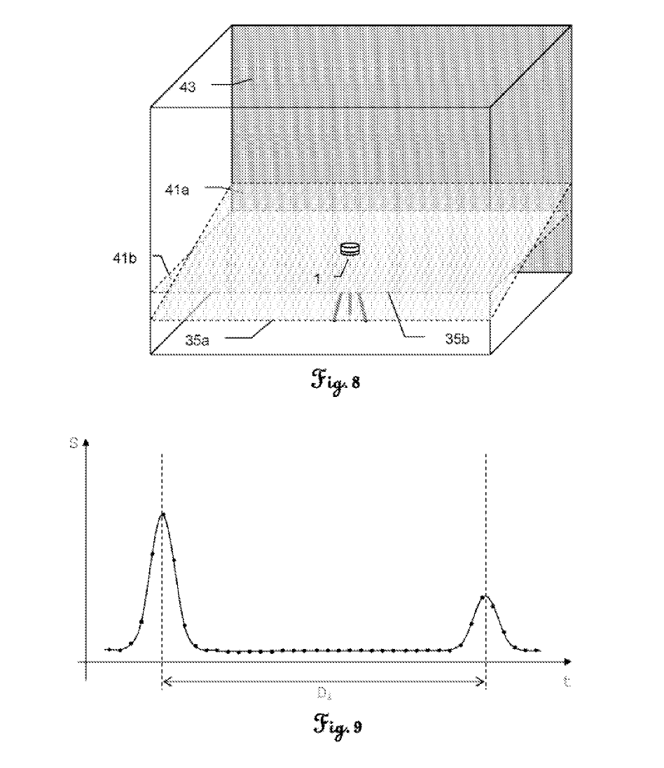

FIG. 8 shows a rotating laser according to the invention in the upright position with projections of laser planes.

FIG. 1 shows a rotating laser 1 according to the present invention in a side view. The rotating laser 1 comprises a base 2 and a laser unit 3 for generating a laser area, the laser unit 3 being mounted by means of a swivel device 4 so that it can swivel with respect to the base 2. The swivel device 4 allows the laser unit 3 to swivel about an X axis and a Y axis (not shown) and therefore to swivel in two directions. The laser unit furthermore has a hollow axle 5, which is connected in its central region to the swivel device 4. The axle has a lower end 6 and an upper end 7. A laser collimator unit 8 is provided at the lower end 6 inside the hollow axle 5. The laser collimator unit 8 may furthermore comprise at least one laser beam source 9, for example a laser diode, and a collimator 10, the unit 8 generating a collimator laser beam 11 parallel to the hollow axle 5 along a midline 12 in the direction of a laser head 13. The laser head 13 has an optically transparent cover 14, which is arranged rotatably with respect to the hollow axle 5 by means of two bearings 15, 16. A deflection means 17 in the form of a prism is integrated into the cover 14, so that the direction of the laser beam 11 can be changed by an angle of 90°. Owing to the fact that the deflection means 17 is rotated with the cover 14, a laser area is generated, in which the laser beam 11 is rotated about a rotation axis 18. The rotation axis 18 is concentric with the midline 12 of the hollow axle 5. The laser head 13 furthermore comprises a motor for rotating the cover 14. At the lower end 6 of the axle 5, an inclination sensor 19 is provided. The inclination sensor 19 is fitted on a sensor platform 20 having a circuit 21. The sensor platform 20 is formed so that it can swivel with respect to the axle 5 with two bearings 22, 23. In a particular embodiment, two inclination sensors may be provided on the platform 20, one sensor measuring the inclination of the rotation axis 18 with respect to the X axis and the other the inclination with respect to the Y axis. In addition, control means 50, which are suitable for implementing a functionality according to the invention for the orientation of a laser plane, are arranged on the rotating laser 1.

FIG. 2 shows a rotating laser 1 according to the invention, which projects a laser beam 11 onto a surface 32, the rotating laser 1 being in a lay-down position tilted through 90°. The laser beam 11 is moved along a reference path, and thereby defines a laser area 34 and, on the surface 32, a reference line 35. The laser area 34 can furthermore be swiveled about an axis 36, and its inclination with respect to the surface 32 can thereby be varied. The laser area 34 is in this case in an arbitrary orientation relative to the surface 32 and can be orientated perpendicularly relative thereto by implementing the functionality according to the invention, as shown in FIG. 3.

FIG. 3 shows a rotating laser 1 according to the invention, defining a laser area 34a, 34b, likewise in a state tilted through 90°. The laser area 34a is in an undetermined inclination relative to the surface 32, and in this case defines a reference line 35a. According to the invention, the laser area 34a is oriented with respect to the surface 32 by implementing a functionality, in such a way that the laser area 34b is perpendicular relative to the surface 32. For this, the laser area 34a, 34b may automatically be guided over the surface 32 in a swivel range by swiveling about an axis 36, while measuring the range to the reference line 35a, 35b, a reference line range. The reference line range determined are compared with one another, and the range which has the shortest distance from the surface 32 to the rotating laser 1 is derived thereby. In the orientation shown for the laser area 34b, a measured range from the rotating laser 1 to a reference line 35b on the surface 32 is the shortest. With projection of the laser area 34b in such a way that the reference line 35b lies in the plane containing the laser area, it therefore follows that the laser area 34b is perpendicular to the surface 32.

In order to illustrate the orientation functionality according to the invention, FIG. 4 shows a determination of a position for a perpendicularly orientated laser area. For this, the rotating laser 1 may in turn emit a laser beam 11 as a reference beam, in which case the latter, by deflection with the aid of moved deflection means, may define a laser area and therefore a reference line 35 on the surface 32. On this reference line 35, the range d to a point 37 may be measured continuously, the position of the point 37 on the reference line been predetermined and maintained by an emission angle of the laser beam 11, with respect to the rotation axis 18 of the rotating laser 1, remaining constant for all measurements. The laser beam 11 is in this case swiveled in a swivel range 38 in a perpendicular direction with respect to the reference line. After running through the swivel range 38, the position for the point 37a with the shortest measured range d can be determined and the laser beam 11 can be orientated thereon, i.e. a laser area can be projected onto the surface 32, so that the latter contains the point 37a and is therefore perpendicular to the surface 32. Furthermore, the rotating laser 1 may have an inclination sensor 39, and thereby process information about the position of the rotating laser 1. With an orientation of the reference line 35 parallel to the gravitational field of the Earth, both a perpendicular projection relative to the surface 32 and, in particular simultaneously, a vertical projection of a reference line 35, or a laser area, can be carried out.

FIGS. 5a and 5b show the profile of a determination according to the invention of a perpendicular orientation of a laser area with the aid of measurement values measured to a point, on a reference line, it is defined with the aid of a predetermined emission angle. FIG. 5a represents a measurement curve 40, the profile of which is obtained from recorded ranges d and swivel angles α during the swiveling of the laser area. The ranges may be recorded in different intervals, for example as a function of the angle variation—here in 1° steps—and assigned to the respective angles α. By the curve shown, in this example the angular setting for the point with the shortest measured range d can be determined very rapidly. The rotating laser may run through a swivel range of for example ±10°, only a section of the range from −8° to 0° being represented here. The range d from the rotating laser to the surface at an angle α of −8° is 3022.2 mm, decreases at −7° to 3015.2 mm and reaches a minimum of 3000 mm at −4°. With further displacement of the laser up to 0°, the measured ranges d increase again to 3007.3 mm. The shortest distance is therefore recorded as 3000 mm with an angular setting of −4°. At this angle α relative to the rotating laser, a laser area which can be perpendicular relative to the surface can then be emitted and orientated at the surface. The shortest range d can also be determined in that, during the recording of the measurement curve 40, a minimum in its profile is established, for example in the event of an increase in the measured ranges d after the values have previously exhibited a decrease in the range d, and swiveling of the laser area is stopped. The minimum found can then represent the shortest range d from the point on the reference line to the rotating laser as a function of the angular setting of the laser area. The measurement values recorded may furthermore be stored in a table, as shown in FIG. 5b, and assigned to one another. In this way, for example after selection of a particular range d, the corresponding angle α can be set rapidly and the associated position on a wall can be marked.

FIG. 6a shows, in a space 42, a rotating laser 1 according to the invention which, in contrast to the previously represented embodiments, defines a laser plane 41 by means of a rotating laser beam 11. The laser plane 41 meets the bottom, top and wall 43 of the space 42, and thereby generates a continuous reference line 35. The intersections A, B, C, D of the reference line 35 with the edges of the space 42 are furthermore represented. The laser plane 41 shown is in an undetermined orientation relative to the wall 43. The perpendicular orientation, according to the invention, of such a laser plane 42 relative to the wall 43 is represented in FIG. 7.

FIG. 6b shows the profile of a range measurement along a reference line of FIG. 6a. The angular setting of the rotation axis of the rotating laser is represented by the corner points A, B, C, D of the reference line. With the aid of this representation, a user of a rotating laser according to the invention can be provided with a selection possibility of orientating a laser area with respect to a desired area. For example, the user may select the region between the points B and C, and therefore carry out the orientation perpendicularly relative to the wall 43 in FIG. 6a. In addition, the user may also select two regions, for example the region between points B and C and the region between points D and A, in particular the regions for two walls which lie parallel opposite one another. Subsequently, the laser plane can be orientated in such a way that it is perpendicular relative to the two parallel walls. In the case of non-parallel walls, orientation of the laser plane is carried out so that the reference line of the laser plane on the two walls has an equal distance respectively to the reference line with the shortest range from the rotating laser.

FIG. 7 shows another embodiment of a rotating laser 1 according to the invention, having a spanned laser plane 41a, 41b and a respectively continuous reference line 35a, 35b. The laser plane 41a with the generated reference line 35a is directed at the wall 43 at a previously undetermined angle β relative to the wall 43. By using the functionality for orientation of laser areas, the laser plane 41b is orientated at a 90° angle φ relative to the wall 43, and is therefore perpendicular thereto. For the orientation of the laser plane 41a, the range from the rotating laser 1 to the reference line 35a may be determined in various ways, and compared with one another as a function of the inclination of the laser planes 41a, 41b relative to the wall 43. For example, the ranges to points 37 on the reference line 35a are measured with a predetermined resolution and, by comparing the ranges, a minimum value is determined which corresponds to the range to the reference line 35a. As an alternative to this, it is also possible to determine the ranges to only two points 37, derive a profile of the reference line 35a from the angular setting of the rotation axis of the rotating laser 1 and the ranges, and calculate mathematically therefrom a perpendicular distance to the rotating laser, which corresponds to the range to the reference line 35a.

FIG. 8 shows a rotating laser 1 according to the invention, which is operated in an upright position. A laser plane 41a is defined at an undetermined angle relative to the wall 43 by the rotating laser, and generates a reference line 35a. After implementing the functionality for orientation of laser areas, or laser planes 41a, 41b according to the invention, the laser plane 41b is projected perpendicularly relative to the wall 43. In particular, perpendicular, in particular horizontal, orientation of laser planes 41a, 41b in spaces can thus be carried out, for example in order to generate a marking in the form of a reference line 35a, 35b on walls 43 as an orienting aid in building work.

FIG. 9 explains a particular range measurement principle, namely a waveform digitization method (WFD=waveform digitizer), for a rotating laser according to the invention with the aid of a schematic representation of a typical signal sequence, as occurs in this case in an electronic range measurement unit. The signal profile is represented against the time axis, the points denoting sampling points. The left-hand pulse in this case represents a start pulse and the right-hand pulse represents a stop pulse. The time of flight, and therefore the distance Di, follow for example from the time difference of the peaks of the two pulses, the pulses being digitally sampled in a similar way as in phase meters. The solution is in this case based on the combination of two basic signal detection principles which are customary in range measurement. The first basic principle is based on measurement signal detection with the aid of the threshold value method, and the second basic principle is based on signal sampling with downstream signal processing for identification and temporal position determination of the signal. In the threshold value method, the signal detection is usually established by the signal amplitude exceeding a threshold value, although the distance-determining signal feature may exist in various forms. On the one hand, the leading edge of the reception signal may release a time trigger, on the other hand the reception signal may be converted by means of an electronic filter into another suitable form, in order to generate a trigger feature, which is advantageously independent of the pulse amplitude. The corresponding trigger signal is delivered as a start or stop signal of a time measurement circuit. Both approaches are used in parallel for the signal detection, that is to say a received pulse or a signal structure is detected by both methods, which usually implies simultaneity or at least temporal overlap of the methods.

The core of the principle is loss-free signal acquisition, loss-free being intended to be interpreted in the sense of preserving the time-of-flight information. The approach based on direct signal sampling of the received time signal in the GHz band. In the signal profile represented, the sampling points are distributed essentially equidistantly (with respect to the time axis), the spacings being maintainable with an accuracy of less than 5 psec. The pulse can be directed by a transmission unit to the target object to be measured and fed through reception optics to a photodetector. The time signal resulting therefrom contains at least one start pulse and one stop pulse corresponding to every optically scanned target.

In the scope of the signal analysis, the time axis or the digital signal vector, is searched for a start pulse and any stop pulses. The position of the pulses is therefore known accurately to one sampling interval. The difference of the pulse positions corresponds in this case to a first rough estimate of the distance Di to be determined.

In order to improve the measurement accuracy, various hardware and software methods are known. For example, by means of centroid value evaluation of the two pulses, interpolation is possible typically to one hundredth of the time interval. Other methods are digital Fourier transformation (DFT) with phase evaluation or differentiation with zero crossing determination. Preferably, evaluation methods are used which are robust in relation to signal distortion and saturation. Here, approaches from digital filtering and estimation theory are often used. With such methods, for example, 1 mm measurement accuracies are achievable.

1-15. (canceled)

16. A rotating laser comprising:
a source of electromagnetic radiation, in particular a laser beam source, for generating a reference beam;
deflection means, which can be rotated about a rotation axis, for rotating emission of the reference beam, so that a laser area is defined, the reference beam travelling along a reference path and at least a part of the reference path being perceptible as a reference line visually and/or by means of a detector on a surface;
swiveling means for swiveling the rotation axis about at least one swivel axis, in particular about two swivel axes;
a range measurement unit for measuring ranges to points on the reference path; and
control means for controlling the swiveling means and for comparing ranges, wherein:
the rotating laser has a functionality for perpendicular orientation of the laser area relative to the surface, the control means being formed in such a way that the following steps are carried out automatically:
varying inclination of the laser area relative to the surface by swiveling the rotation axis, determination of a reference line range from the reference line to the rotating laser respectively being carried out for the respective inclination angles,
determination of that inclination angle of the laser area as a perpendicular inclination angle, for which the laser area contains the reference line with shortest reference line range and is therefore perpendicular relative to the surface.

17. The rotating laser as claimed in claim 16, wherein the source of electromagnetic radiation includes a laser beam source and the swiveling means for swiveling the rotation axis about two swivel axes.

18. The rotating laser as claimed in claim 16, wherein:
the following additional step is carried out in the scope of the functionality:
adjustment of the inclination angle of the laser area to the perpendicular inclination angle; or
in the scope of the functionality, orientation of a laser area relative to a first and a second surface, lying opposite the first, is carried out with the following steps:
with the varying inclination of the laser area, reference line ranges to reference lines lying on the first and second surface are determined;
for the first and second surface, the determination of two inclination angles of the laser area is carried out as a first and second perpendicular inclination angle, for which the laser area respectively contains a first and second reference line with a respective first and second shortest reference line range, and is therefore perpendicular relative to the first and/or second surface; and
adjustment of the inclination angle of the laser area to a central, in particular arithmetically averaged, inclination angle between the first and second perpendicular inclination angles.

19. The rotating laser as claimed in claim 16, wherein:
the inclination angles and the reference line ranges respectively determined therefor are linked together to form value pairs and stored in a database, particularly in a table, in particular with the range measurement being carried out at least with parts of the reference beam reflected at the surface; and/or
the rotating laser comprises means for determining an emission angle of the reference beam with the aid of a rotational setting of the deflection means, and measurement values for ranges to points at defined emission angles are accumulated and an average value for measured ranges is determined.

20. The rotating laser as claimed in claim 16, wherein the determination of the reference line range to the rotating laser is carried out with the aid of the range measurement to a point on the reference line, a position of the point on the reference line being defined by a predetermined emission angle of the reference beam, and the predetermined emission angle being maintained during swiveling of the laser area in a direction perpendicular to the laser area, and the range to the point being taken into account as the reference line ranges to the rotating laser.

21. The rotating laser as claimed in claim 16, wherein
the determination of the reference line range to the rotating laser is carried out by measurement of ranges and determination of emission angles to:
at least two points on the reference line, a profile of the reference line being derived from the ranges and the emission angles, and the shortest path from the rotating laser to the reference line being calculated mathematically, this being taken into account as the reference line range to the rotating laser, and/or
a multiplicity of points on the reference line with a predetermined resolution.

22. The rotating laser as claimed in claim 16, wherein
the determination of the reference line range to the rotating laser is carried out by measurement of ranges and determination of emission angles to:
at least two points on the reference line, a profile of the reference line being derived from the ranges and the emission angles, and the shortest path from the rotating laser to the reference line being calculated mathematically, this being taken into account as the reference line range to the rotating laser, and/or
a multiplicity of points on the reference line with a predetermined resolution with a resolution of 5-50 points per 10° of angle variation of the deflection means, a minimum range being determined by a comparison of ranges to the points with a minimum range being determined by a calculation of a minimum of a function representing the ranges and emission angles, this being taken into account as the reference line range to the rotating laser.

23. The rotating laser as claimed in claim 16, wherein:
the varying inclination of the laser area for the determination of the shortest reference line range to the rotating laser being carried out until a minimum is established in a profile of a measurement curve recorded in this case; and/or
the rotating laser comprises a laser core module having a laser beam source and having the deflection means, which can be rotated about the rotation axis and which are provided as a guide means for a laser beam, the laser beam being emitted parallel to the rotation axis and the laser core module being swivelable about at least one axis, in particular about two axes.

24. The rotating laser as claimed in claim 16, wherein the range measurement unit comprises an emission unit and a reception unit, and is formed in such a way that emission and reception of a measurement beam for the range measurement take place in a parallel direction, in particular coaxially, in particular with the range measurement being carried out by means of waveform digitization.

25. The rotating laser as claimed in claim 16, wherein the rotation axis can be automatically orientated horizontally or vertically by means of the swiveling means, in particular with the rotation axis being orientatable horizontally or vertically as a function of a measurement value of an inclination sensor.

26. The rotating laser as claimed in claim 16, wherein the rotation axis can be automatically orientated horizontally or vertically by means of the swiveling means with the rotation axis being orientatable horizontally or vertically as a function of a measurement value of an inclination sensor.

27. The rotating laser as claimed in claim 16, wherein at least a first and a second projection inclination angle can be adjusted as an inclination angle for the laser area, in such a way that there is a defined distance between the reference lines generated on the surface with the at least two projection inclination angles.

28. The rotating laser as claimed in claim 16, wherein at least a first and a second projection inclination angle can be adjusted as an inclination angle for the laser area, in such a way that there is a defined distance between the reference lines generated on the surface with the at least two projection inclination angles with a multiplicity of projection inclination angles being adjustable and the distances between two respectively neighboring reference lines thereby generated on the surface being identical.

29. A method for the perpendicular orientation of a laser area defined by emission, rotating about a rotation axis, of a reference beam, relative to a surface, the reference beam travelling along a reference path and at least a part being perceptible as a reference line visually and/or by means of a detector on the surface comprising the following steps:
varying inclination of the laser area relative to the surface with determination of a reference line range from the reference line to the rotating laser respectively being carried out for the respective inclination angles; and
determination of that inclination angle of the laser area as a perpendicular inclination angle, for which the laser area contains the reference line with shortest reference line range and is therefore perpendicular relative to the surface.

30. The method as claimed in claim 29, wherein the method comprises the following additional step:
adjustment of the inclination angle of the laser area to the perpendicular inclination angle; or
in the scope of a refinement of the method, orientation of a laser area relative to a first and a second surface, lying opposite the first, is carried out with the following steps:
with the varying inclination of the laser area, reference line ranges to reference lines lying on the first and second surface are determined,
for the first and second surface the determination of two inclination angles of the laser area is carried out as a first and second perpendicular inclination angle, for which the laser area respectively contains a first and second reference line with a respective first and second shortest reference line range, and is therefore perpendicular relative to the first and/or second surface, and
adjustment of the inclination angle of the laser area to a central inclination angle between the first and second perpendicular inclination angles.

31. The method as claimed in claim 32, wherein adjustment of the inclination angle of the laser area to a central is an arithmetically averaged inclination angle between the first and second perpendicular inclination angles.

32. The method as claimed in claim 29, wherein:
before the perpendicular orientation of the laser area, the laser area is orientated roughly perpendicularly to the surface, in particular with orientation of the laser area being carried out parallel or perpendicular to the gravitational field, in particular horizontally or vertically, and/or
an absolute position of at least one point, in particular of a plurality of points, on the reference path is determined in relation to an external coordinate system, an emission angle being recorded according to a setting of a rotation axis provided for guiding the reference beam, and the range to this point being measured, in particular with the coordinates of the point on the reference path being determined in relation to the external coordinate system.

33. The method as claimed in claim 29, wherein the determination of a reference line range is carried out by means of emission and reception of a measurement beam, the emission and reception taking place in parallel directions.

34. The method as claimed in claim 29, wherein the determination of a reference line range is carried out by means of emission and reception of a measurement beam, the emission and reception taking place coaxially with the reference line range being determined by means of waveform digitization.

35. The method as claimed in 29, wherein at least a first and a second projection inclination angle are adjusted as an inclination angle for the laser area, in such a way that there is a defined distance between the reference lines generated on the surface with the at least two projection inclination angles.

35. The method as claimed in 29, wherein at least a first and a second projection inclination angle are adjusted as an inclination angle for the laser area, in such a way that there is a defined distance between the reference lines generated on the surface with the at least two projection inclination angles with a multiplicity of projection inclination angles being adjusted and the distances between two respectively neighboring reference lines thereby generated on the surface being identical.

36. A tangible non-transitory computer program product which is stored on a machine-readable medium having program code for carrying out the method as claimed in claim 29 when the program is run in an electronic data processing unit of a rotating laser.
